(19) United States
(12) Patent Application Publication
(10) Pub. No.: US 2023/0160395 A1
(43) Pub. Date: May 25, 2023

(54) Rotor Disk Having a Curved Rotor Arm for an Aircraft Gas Turbine

(71) Applicant: MTU Aero Engines AG, Muenchen (DE)

(72) Inventors: Thomas BINSTEINER, Munich (DE); Knut WERNER, Munich (DE)

(21) Appl. No.: 17/894,419

(22) Filed: Aug. 24, 2022

(30) Foreign Application Priority Data
Sep. 7, 2021 (DE) 102021123173.6

(51) Int. Cl. F04D 29/38; B64D 27/10

(52) U.S. Cl. CPC F04D 29/388; B64D 27/10; F05D 2220/323

(57) ABSTRACT

Described is a rotor disk (40) for a compressor (29, 32) of a gas turbine, in particular an aircraft gas turbine (10), the rotor disk having a main body (42), at least one rotor arm (44) projecting from the main body (42) in the axial direction (AR), the rotor arm (44) having, in a sectional view taken in a sectional plane defined by the axial direction (AR) and the radial direction (RR) a beginning portion (44a) merging into the main body (42); an end (44e) portion remote from the main body (42) and forming a kind of free end in the axial direction (AR), the beginning portion (44a) and the end portion (44e) being interconnected by an intermediate portion (44z), characterized in that the intermediate portion (44z) is curved with at least one radius of curvature (Ri, Ra).

This claims the benefit of German Patent Application DE102021123173.6, filed on Sep. 7, 2021 and which is hereby incorporated by reference herein

The present invention relates to a rotor disk for a compressor of a gas turbine, in particular an aircraft gas turbine.

Directional words such as “axial,” “axially,” “radial,” “radially,” and “circumferential” are taken with respect to the machine axis of the gas turbine, unless explicitly or implicitly indicated otherwise by the context.

### SUMMARY OF THE INVENTION

In a compressor, in particular a high-pressure compressor, of an (aircraft) gas turbine, axial clamping forces are transmitted by the rotor arm of one rotor disk to an axially adjacent rotor disk, so that the plurality of rotor disks, which are clamped against one another by axial tension forces, can be stabilized. In the case of axially adjacent rotor disks which differ significantly in diameter, the problem arises that a relatively large radial distance must be spanned by the rotor arm to support the acting clamping forces. Therefore, existing rotor arms have at least one sharp bend and possibly also variations in material thickness, which results in undesired stresses in the rotor arm.

It is an object of the invention to provide a rotor disk that enables axial force transmission with reduced stresses.

Accordingly, there is provided a rotor disk for a compressor of a gas turbine, in particular an aircraft gas turbine, the rotor disk having
a main body,
at least one rotor arm projecting from the main body in the axial direction,
the rotor arm having, in a sectional view taken in a sectional plane defined by the axial direction and the radial direction: a beginning portion merging into the main body;
an end portion remote from the main body and forming a free end in the axial direction, the beginning portion and the end portion being interconnected by an intermediate portion.

It is provided that the intermediate portion be curved with at least one radius of curvature.

The curved or bent configuration of the intermediate portion allows axially acting (clamping) forces to be transmitted with little stress. The curvature avoids sharp bends in the shape of the rotor arm, where local stress peaks may occur in the bend regions, which may undesirably result in material fatigue. It should be noted that the radius of curvature and a respective center of the curved intermediate portion are located in the specified sectional plane.

In the rotor disk, the beginning portion, the end portion and the intermediate portion may have substantially the same rotor arm thickness. In other words, the two substantially straight beginning and end portions and the curved intermediate portion together form a rotor arm of substantially the same thickness along its axial length. The rotor arm thickness may be about 0.3 cm to 1.3 cm.

In the rotor disk, at least one radially outwardly directed sealing fin may be disposed on the rotor arm. The at least one sealing fin is disposed radially opposite a sealing element which is attached to a stator or stator vane ring and usually has a honeycomb structure and into which the sealing fin may rub in certain operating conditions of the gas turbine in order to provide a seal.

In the rotor disk, the radius of curvature of the intermediate portion may be from about 2 cm to 6 cm, in particular about 2.5 cm to 5.1 cm.

A rotor blade disk for a compressor of a gas turbine, in particular an aircraft gas turbine, may have a rotor disk as described above, the rotor blade disk having a plurality of rotor blades arranged adjacent one another in the circumferential direction and connected to the rotor disk.

In the rotor blade disk, the rotor disk and the rotor blades may be formed integrally with each other, in particular as a blisk.

A compressor, in particular a high-pressure compressor, for a gas turbine, in particular an aircraft gas turbine, may have at least one rotor disk as described above or at least one rotor blade disk as described above.

An aircraft gas turbine may be equipped with such a compressor, in particular a high-pressure compressor.

### BRIEF DESCRIPTION OF THE DRAWINGS

The invention will now be described by way of example, and not by way of limitation, with reference to the accompanying drawings.

FIG. 1 is a simplified schematic representation of an aircraft gas turbine;

FIG. 2 is a simplified sectional view showing a portion of a compressor, specifically the region between two rotor blade disks;

FIG. 3 is an enlarged view of a rotor arm of FIG. 2.

### DETAILED DESCRIPTION

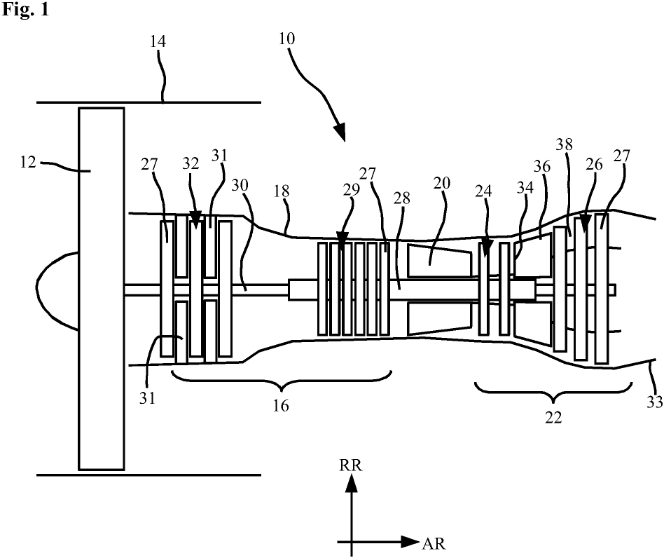

FIG. 1 shows, in simplified schematic form, an aircraft gas turbine 10, illustrated, merely by way of example, as a turbofan engine. Gas turbine 10 includes a fan 12 surrounded by a schematically indicated casing 14. Disposed downstream of fan 12 in the axial direction AR of gas turbine 10 is a compressor 16 that is accommodated in a schematically indicated inner casing 18 and may be single-stage or multi-stage. Disposed downstream of compressor 16 is combustor 20. The flow of hot exhaust gas exiting the combustor then flows through the downstream turbine 22, which may be single-stage or multi-stage. In the present example, turbine 22 includes a high-pressure turbine 24 and a low-pressure turbine 26. A hollow shaft 28 connects high-pressure turbine 24 to compressor 16, in particular a high-pressure compressor 29, so that they are jointly driven or rotated. Another shaft 30 located further inward in the radial direction RR of the turbine connects low-pressure turbine 26 to fan 12 and to a low-pressure compressor 32 so that they are jointly driven or rotated. Disposed downstream of turbine 22 is an exhaust nozzle 33, which is only schematically indicated here.

In the illustrated example of an aircraft gas turbine 10, a turbine center frame 34 is disposed between high-pressure turbine 24 and low-pressure turbine 26 and extends around shafts 28, 30. Hot exhaust gases from high-pressure turbine 24 flow through turbine center frame 34 in its radially outer region 36. The hot exhaust gas then flows into an annular space 38 of low-pressure turbine 26. Compressors 29, 32 and turbines 24, 26 are represented, by way of example, by rotor blade rings 27. For the sake of clarity, the usually present stator vane rings 31 are shown, by way of example, only for compressor 32.

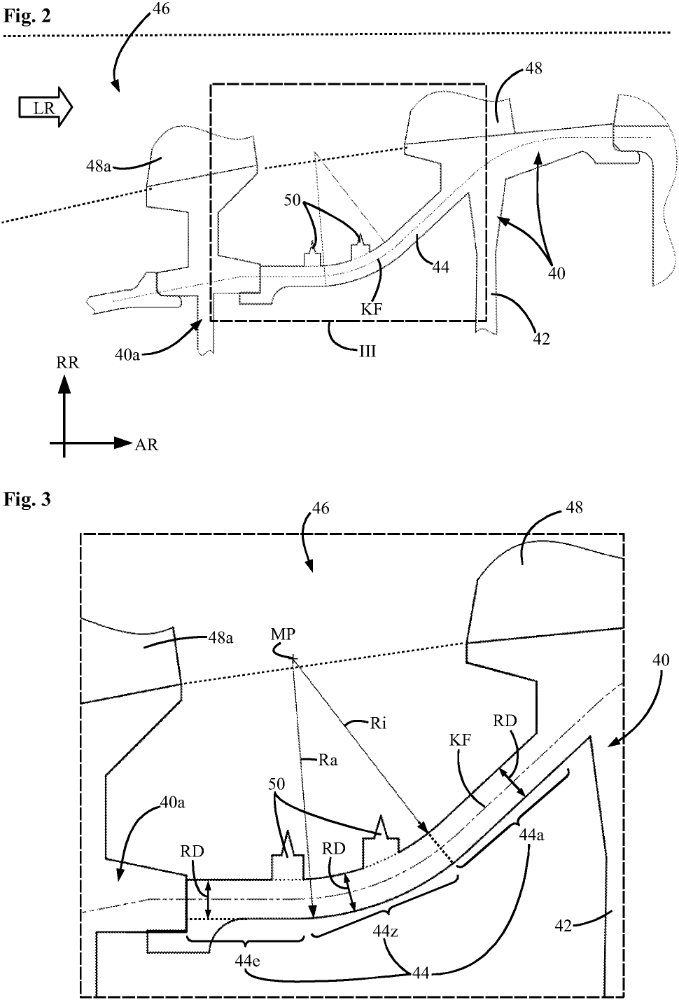

The invention will now be described in more detail with simultaneous reference to FIGS. 2 and 3, FIG. 3 being an enlarged view of the portion designated III in FIG. 2.

FIG. 2 shows a rotor disk 40 having a main body 42 and a rotor arm 44. Rotor arm 44 is connected to main body 42. When viewed relative to the direction of air flow LR through an annular space 46 schematically indicated by short-dashed lines, another rotor disk 40a is disposed upstream of rotor disk 40. The two rotor disks 40, 40a are clamped against one another.

Rotor arm 44 of rotor disk 40 bears against rotor disk 40a in axial direction AR and radial direction RR, which allows transmission of acting forces of the axial clamping. A rotor blade 48 is connected to rotor disk 40. Rotor disk 40a also has a rotor blade 48a connected thereto. With regard to rotor blades 48 and 48a, it should be noted that these blades may be formed integrally with the respective rotor disk 40 and 40a, in particular as what is known as a blisk. Alternatively, however, it is also conceivable that rotor disks 40 and 40a may have openings formed therein in which rotor blade roots of rotor blades may be interlockingly received.

Rotor arm 44 can be divided into a beginning portion 44a, an end portion 44e, and an intermediate portion 44z, as shown in FIG. 3. Beginning portion 44a is connected to main body 42 and extends obliquely to axial direction AR and to radial direction RR. Beginning portion 44a is substantially straight.

End portion 44e rests against the axially forward rotor disk 40a. End portion 44e extends substantially parallel to axial direction AR and substantially orthogonal to radial direction RR. Due to the end portion 44e extending substantially parallel to axial direction AR, axially acting forces can be optimally transmitted and supported. In FIGS. 2 and 3, the flow of force along axial direction AR in rotor arm 44 and rotor disks 40, 42a is indicated in simplified form by a dash-dotted line KF.

The intermediate portion 44z extending between beginning portion 44a and end portion 44e is curved or bent and has an inner radius Ri and an outer radius Ra relative to a center MP. The two radii Ri and Ra are selected such that intermediate portion 44z has a substantially uniform rotor arm thickness RD. Beginning portion 44a and end portion 44e also have a rotor arm thickness RD that is substantially uniform. In other words, the entire rotor arm 44 has a continuous thickness RD that is maintained substantially constant. Radius of curvature Ri or Ra of intermediate portion 44z has a length of about 2 cm to 6 cm, in particular of about 2.5 cm to 5.1 cm. The substantially constant thickness RD of rotor arm 44 is about 0.3 to 1.3 cm.

The selected arrangement of the obliquely extending beginning portion 44a and the adjoining curved intermediate portion 44z allows forces acting due to the axial clamping to be optimally transmitted with little stress from the rotor disk 40 of larger diameter to the rotor disk 40a of smaller diameter, without local stress peaks occurring in rotor arm 44, and specifically in intermediate portion 44z.

Rotor arm 44 may have at least one sealing fin 50 provided thereon which, in an assembled state of a compressor, is disposed opposite an abradable sealing element of a stator or stator vane ring.

A rotor disk 40 having the curved rotor arm 44, as described with reference to FIGS. 2 and 3, may be disposed, for example, in a high-pressure compressor 29 of an aircraft gas turbine 10, as shown in FIG. 1. The rotor blades 48 and 48a may form part of a rotor blade ring 27 indicated in FIG. 1.

LIST OF REFERENCE NUMERALS

| | |
|---|---|
| 10 | aircraft gas turbine |
| 12 | fan |
| 14 | casing |
| 16 | compressor |
| 18 | inner casing |
| 20 | combustor |
| 22 | turbine |
| 24 | high-pressure turbine |
| 26 | low-pressure turbine |
| 28 | hollow shaft |
| 29 | high-pressure compressor |
| 30 | shaft |
| 31 | stator vane ring |
| 32 | low-pressure compressor |
| 33 | exhaust nozzle |
| 34 | turbine center frame |
| 36 | radially outer region |
| 38 | annular space |
| 40,40a | rotor disk |
| 42 | main body |
| 44 | rotor arm |
| 44 a | beginning portion |
| 44 e | end portion |
| 44 z | intermediate portion |
| 46 | annular space |
| 48.48a | rotor blade |
| 50 | sealing fin |
| AR | axial direction |
| LR | direction of air flow |
| MP | center |
| Ra | outer radius |
| RD | rotor arm thickness |
| Ri | inner radius |
| RR | radial direction |

What is claimed is:

1-8. (canceled)

9. A rotor disk for a compressor of a gas turbine, the rotor disk comprising:
a main body;
at least one rotor arm projecting from the main body in an axial direction, the rotor arm having, in a sectional view taken in a sectional plane defined by the axial direction and the radial direction:
a beginning portion merging into the main body,
an end portion remote from the main body and forming a free end in the axial direction, and
an intermediate portion interconnecting the beginning portion and the end portion, the intermediate portion being curved with at least one radius of curvature.

10. The rotor disk as recited in claim 9 wherein the beginning portion, the end portion and the intermediate portion have substantially a same rotor arm thickness.

11. The rotor disk as recited in claim 9 further comprising at least one radially outwardly directed sealing fin disposed on the rotor arm.

12. The rotor disk as recited in claim 9 wherein the radius of curvature is from 2 cm to 6 cm.

13. The rotor disk as recited in claim 9 wherein the radius of curvature is from 2.5 cm to 5.1 cm.

14. A rotor blade disk comprising the rotor disk as recited in claim 9 wherein the rotor blade disk has a plurality of rotor blades arranged adjacent one another in a circumferential direction and connected to the rotor disk.

15. The rotor blade disk as recited in claim 14 wherein the rotor disk and the rotor blades are formed integrally with each other to define a blisk.

16. A compressor for a gas turbine, the compressor comprising the rotor disk as recited in claim 9.

17. The compressor as recited in claim 16 wherein the compressor is a high-pressure compressor.

18. An aircraft gas turbine comprising the compressor as recited in claim 16.
